(19) United States
(12) Patent Application Publication
(10) Pub. No.: US 2005/0150988 A1
(43) Pub. Date: Jul. 14, 2005

(54) Seat belt retractor

(76) Inventors: John Bell, Carlisle (GB); Martyn Palliser, Carlisle (GB)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 10/998,096

(22) Filed: Nov. 29, 2004

(30) Foreign Application Priority Data
Jan. 12, 2004 (EP) 04250120.5

(51) Int. Cl. B60R 22/38

(52) U.S. Cl. 242/382

(57) ABSTRACT

A noise reduction device for use with a vehicle sensor in a seat belt retractor has a part arranged to be frictionally coupled to a retractor spool. An inhibitor arm extends radially from the frictionally coupled part. A counterbalance is arranged on a counterbalance arm extending radially from the frictionally coupled part and circumferentially spaced from the inhibitor arm. The device being arranged such that when rewinding of seat belt webbing onto the spool the inhibitor arm is moved to a first position in which it inhibits the vehicle sensor. When withdrawing of webbing from the spool, the inhibitor arm moves to a second position in which it does not inhibit the vehicle sensor, wherein the counterbalance is weighted and located so as to move the inhibitor arm to the second position if the frictional coupling between the device and the spool fails.

### FIELD OF THE INVENTION

The present invention relates generally to a seat belt retractor for use in a vehicle and in particular to a vehicle sensor for a seat belt retractor.

### BACKGROUND OF THE INVENTION

Conventional seat belt retractors allow a vehicle occupant a reasonable degree of freedom for movement during normal driving conditions to provide a degree of comfort. A seat belt retractor will allow pay out of webbing when gentle tension is applied to the seat belt during normal operation, but will arrest the vehicle occupant's movement during an emergency situation. A sensor detects a vehicle deceleration above a predetermined magnitude, which is indicative of an emergency situation and causes the retractor to lock.

Known vehicle acceleration sensors comprise an inertial mass such as a ball or cup that moves when the vehicle rapidly decelerates. Movement of the inertial mass moves a pivoted lever to activate a locking mechanism to lock the retractor against further pay out of seat belt webbing. The movable parts create noise when unconstrained in a travelling vehicle. Noise hold out mechanisms are known which hold the moveable parts of the sensor mechanism to prevent them from rattling and engaging other parts, thus reducing noise levels in the retractor. These noise hold out mechanisms rely upon frictional forces to ensure correct engagement and disengagement of locking elements during normal driving conditions and crashes respectively.

It is a particular problem with frictional noise hold out mechanisms that a loss of friction between the relevant parts can cause the locking elements to become jammed during a crash and this is undesirable since the retractor will then not function correctly. Accordingly the current invention provides an improved vehicle sensor inhibitor mechanism.

### SUMMARY OF THE INVENTION

According to the present invention there is provided a noise reduction device for use with a vehicle sensor in a seat belt retractor, the device comprising a part arranged to be frictionally coupled to a retractor spool, an inhibitor arm extending radially from the frictionally coupled part and a counterbalance arranged on a counterbalance arm extending radially from the frictionally coupled part and circumferentially spaced from the inhibitor arm, the device being arranged such that on rewinding of seat belt webbing onto the spool the inhibitor arm is moved to a first position in which it inhibits the vehicle sensor, and on withdrawal of webbing from the spool, the inhibitor arm moves to a second position in which it does not inhibit the vehicle sensor, wherein the counterbalance is weighted and located so as to move the inhibitor arm to the second position if the frictional coupling between the device and the spool fails.

This acts as a fail-safe and allows the vehicle sensor to operate uninhibited when the frictional coupling between the retractor spool and the vehicle sensor inhibitor fails.

### BRIEF DESCRIPTION OF THE DRAWINGS

In order that the invention may be clearly understood and readily carried into effect, a preferred embodiment will now be described, by way of example, with reference to the accompanying drawings.

FIG. 1 is a cut-away perspective view of a seat belt retractor according to the present invention.

FIG. 2 is a cross-section view of part of FIG. 1.

FIG. 3 is an end view of the seat belt retractor of FIG. 1.

FIG. 4 is a perspective view of the seat belt retractor of FIG. 1, with a portion of the retractor shown in an exploded format.

### DETAILED DESCRIPTION OF THE INVENTION

Seat belt retractors are well known to persons skilled in the art and generally comprise a frame 50, a spool 51 of seat belt webbing, an emergency spool locking system attached to one side of the frame, and a retraction spring attached to the other side. A typical seat belt retractor is described in EP 0 795 447 A.

The spool 51 is typically mounted to be rotatable within the frame 50 and is biased by the retraction spring to a webbing rewound condition. The emergency locking system comprises a webbing sensor that detects a sudden extraction of the webbing and a vehicle sensor 1 that detects a sudden deceleration of the vehicle, also by inertia means the initial movement of which begins a retractor locking sequence. The vehicle sensor 1 may comprise a mass known as a standing man that generally comprises an upturned cup balanced on a post. The cup tips when acceleration or deceleration of the vehicle exceeds a predetermined limit. Tipping of the cup pivots a sensor lever 11 to begin a locking procedure. A ball and cup form of vehicle sensor is also known wherein a ball rests in a shallow indentation in a cup and moves under the influence of sudden acceleration or deceleration, again to pivot a sensor lever to begin a spool locking procedure.

The vehicle sensor is shown generally at 1 in the figures, and comprises a mass in the form of an upturned cup 10 and a sensor lever 11 mounted in a plastic sensor housing 2 fixed to a mounting plate 28. A locking lever 13 is attached to a multifunction piece 3 which is mounted for limited pivoting about the axis 4 of spool rotation. The multifunction piece 3 is mounted adjacent a toothed ratchet wheel 5 (part of which is visible in a cutout shown at the bottom of the multifunction piece 3). The ratchet wheel is fixed to the spool 51 and rotates with the spool 51. The locking mechanism acts when movement of the multifunction piece 3 moves a load bearing locking pawl 6 to engage the teeth on the ratchet wheel thus locking the spool 51 against rotation. The locking pawl 6 is brought into engagement with the ratchet wheel 5 by rotation of the multifunction piece 3 by interaction of a cam 7 on the load bearing pawl 6 with a cam surface formed by the inside surface of a slot 8 on the multifunction piece 3. As the multifunction piece 3 pivots in the direction of the arrow A, the locking pawl 6 is pivoted about pivot point 9 towards the axis of rotation 4 of the spool, and into engagement with the ratchet wheel 5.

When the upturned cup 10 of the vehicle sensor tips when acceleration or deceleration over a predetermined threshold is reached, the tipping action of the cup 10 causes the sensor lever 11 to pivot upwards about pivot point 12 and this in turn causes a locking lever 13 to pivot upwards.

The locking lever 13 engages teeth on the ratchet wheel 5 so as to lock the multifunction piece 3 to the ratchet wheel. A small further rotation of the spool 51 causes the ratchet wheel, and with it the multifunction piece 3, to pivot a small amount further bringing the locking pawl 6 into full load bearing engagement with the ratchet wheel and stopping further spool rotation.

The inhibitor arm 16 and the counterbalance are preferably mounted to a resilient ring 21 (or even more preferably molded in one piece with such a ring), which is clipped onto a bushing 20 with a spring member such as a wave washer compressed between them to assist the frictional force. This assembly is then assembled onto the end of the spool 51. The bushing 20 is driven by the spool 51 and constantly rotates with the spool. The inhibitor arm 16 rotates only between the first and second positions and thereafter slips on the bushing 20. The inhibitor arm 16, counterbalance 17 and ring 21 may comprise a single molded plastic member 15 which is simple and cheap to manufacture and which may be attached to the retractor in a single assembly step.

The noise reduction device 15 of the invention is commonly known as a noise hold out mechanism. A bushing 20 extending around the pivot axis 4 of the spool 51 is coupled to the device 15 by friction between a resilient ring 21 and the bushing 20, extended by a spring such as a wave washer. The device 15 has two arms: an inhibitor arm 16 which extends generally radially outwards and downwards towards the vehicle sensor 1, and a counterbalance arm 17 also extending radially outwardly from the bushing 20 and circumferentially spaced from the inhibitor arm 16 by an angle which is preferably about 70°. A counterbalance mass 22 is located at the end of the counterbalance arm 17.

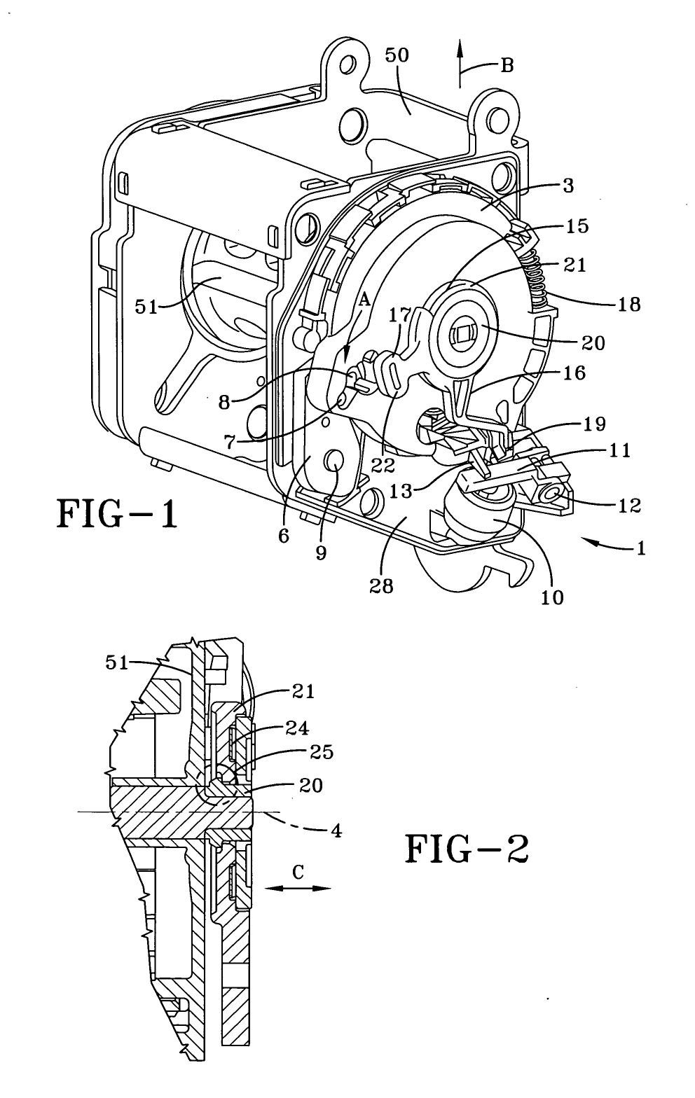

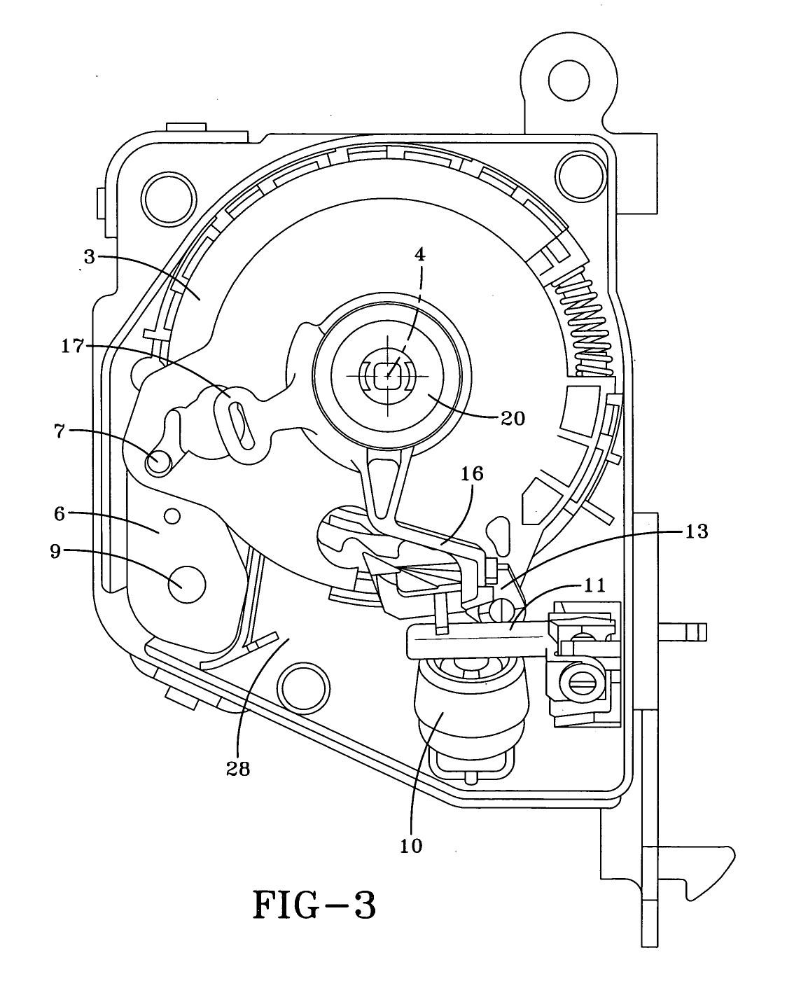

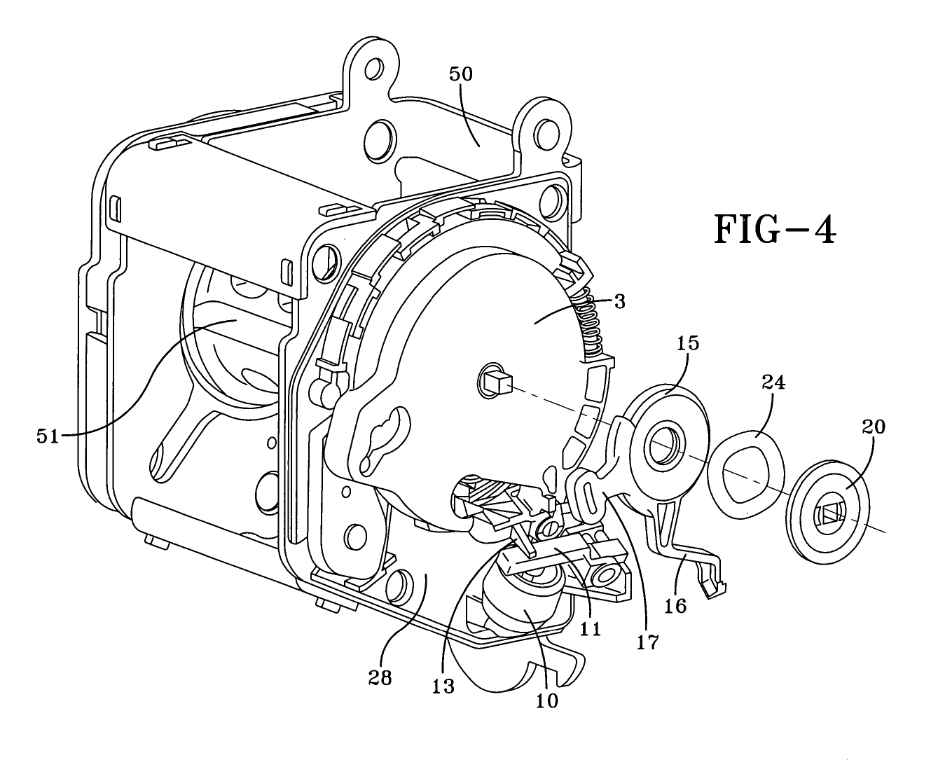

Under normal operation, when webbing is pulled off the spool 51 in a direction indicated by an arrow B in FIG. 1 due to routine movements of the vehicle occupant, then the spool rotates freely and the multifunction piece 3 remains stationary with the locking pawl 6 disengaged.

The multifunction piece 3 is biased to the position shown in the figure by a biasing spring 18.

When webbing is rewound onto the spool 51 in the direction opposite to the arrow B then the device 15 is in the position shown in the figure and an end 19 of the inhibitor arm 16 engages the locking lever 13 and prevents it from contacting the teeth of the ratchet wheel 5. Thus the unwanted noise caused when the locking lever 13 rattles against the teeth of the ratchet wheel 5 is prevented. The device moves with the bushing 20 under friction. The frictionally coupled part of the device 15 is a plastic ring 21 molded and sized to fit around the bushing 20 with a wave washer 24 which pushes the bushing 20 and the arm apart. The inhibitor lever device 15 is clipped to the bushing 20 with the friction created by the pressure of the wave washer 24 pushing the inhibitor lever and the bushing 20 apart as indicated by arrow C and is not influenced by a tight fit between components. The only contact between the inhibitor lever and the bushing is on clips formed in the bushing 20. These are shown in FIG. 2 in the highlighted circle section 25. If the friction of contact between the bushing 20 and the spool fails through wear or the interposition of foreign bodies or of lubricants, then the device will rotate in the direction of arrow A under default condition is that the influence of the counterbalance mass 22 at the end of the counterbalance arm 17. Thus the inhibitor arm 16 releases and allows full movement of the sensor locking lever 13 and the locking sequence may be satisfactorily initiated in the event of a crash.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

1. A seat belt retractor comprising a part arranged to be frictionally coupled to a retractor spool, an inhibitor arm extending radially from the frictionally coupled part and a counterbalance arranged on a counterbalance arm extending radially from the frictionally coupled part and circumferentially spaced from the inhibitor arm, the device being arranged such that on rewinding of seat belt webbing onto the spool the inhibitor arm is moved to a first position in which it inhibits the vehicle sensor, and on withdrawal of webbing from the spool, the inhibitor arm moves to a second position in which it does not inhibit the vehicle sensor, wherein the counterbalance is weighted and located so as to move the inhibitor arm to the second position if the frictional coupling between the device and the spool fails.

2. The seat belt retractor according to claim 1 wherein in the first position the inhibiting arm engages a vehicle sensor locking pawl and prevents pivotal movement thereof.

3. The seat belt retractor according to claim 2 wherein the vehicle sensor locking lever is allowed to pivot when the inhibitor arm is in the second position.

4. The seat belt retractor according to claim 1 wherein the frictionally coupled part is frictionally coupled to the spool via an intermediate member.

5. The seat belt retractor according to claim 2 wherein the frictionally coupled part is frictionally coupled to the spool via an intermediate member.

6. The seat belt retractor according to claim 3 wherein the frictionally coupled part is frictionally coupled to the spool via an intermediate member.

7. The seat belt retractor according to claim 1 wherein the inhibitor arm, the counterbalance arm and the counterbalance are formed integrally with the frictionally coupled part.

8. The seat belt retractor according to claim 2 wherein the inhibitor arm, the counterbalance arm and the counterbalance are formed integrally with the frictionally coupled part.

9. The seat belt retractor according to claim 3 wherein the inhibitor arm, the counterbalance arm and the counterbalance are formed integrally with the frictionally coupled part.

10. The seat belt retractor according to claim 4 wherein the inhibitor arm, the counterbalance arm and the counterbalance are formed integrally with the frictionally coupled part.

11. The seat belt retractor according to claim 5 wherein the inhibitor arm, the counterbalance arm and the counterbalance are formed integrally with the frictionally coupled part.

12. The seat belt retractor according to claim 6 wherein the inhibitor arm, the counterbalance arm and the counterbalance are formed integrally with the frictionally coupled part.

13. The seat belt retractor according to claim 1 wherein the inhibitor arm, the counterbalance arm and the counterbalance are formed by injection molding as a single part.

14. The seat belt retractor according to claim 2 wherein the inhibitor arm, the counterbalance arm and the counterbalance are formed by injection molding as a single part.

15. The seat belt retractor according to claim 3 wherein the inhibitor arm, the counterbalance arm and the counterbalance are formed by injection molding as a single part.

16. The seat belt retractor according to claim 4 wherein the inhibitor arm, the counterbalance arm and the counterbalance are formed by injection molding as a single part.

17. The seat belt retractor according to claim 5 wherein the inhibitor arm, the counterbalance arm and the counterbalance are formed by injection molding as a single part.

18. The seat belt retractor according to claim 6 wherein the inhibitor arm, the counterbalance arm and the counterbalance are formed by injection molding as a single part.
